(19) United States
(12) Patent Application Publication
(10) Pub. No.: US 2004/0242289 A1
(43) Pub. Date: Dec. 2, 2004

(54) Configuration driven automatic antenna impedance matching

(76) Inventors: Roger Jellicoe, Woodstock, IL (US); Tateshi Yamada, Bellevue, WA (US); Yiu-Kwong Chan, Vernon Hills, IL (US)

Correspondence Address: MOTOROLA INC, 600 NORTH US HIGHWAY 45, ROOM AS437, LIBERTYVILLE, IL, 60048-5343, US

(21) Appl. No.: 10/452,353

(22) Filed: Jun. 2, 2003

(51) Int. Cl. H04Q 7/20

(52) U.S. Cl. 455/575.1; 455/90.3

(57) ABSTRACT

An apparatus (100) and method (1800) for selecting an appropriate impedance for an antenna (104) based upon a current configuration of a configurable housing 102 are provided. A configuration detector (118) detects the current configuration of the configurable housing (102) of a wireless communication device (100) and a corresponding impedance matching circuit from a matching circuit block (120) is selected and is presented to the antenna (104).

### FIELD OF THE INVENTION

The present invention generally relates to an apparatus and a method for antenna impedance matching, and more specifically to an apparatus and a method for automatically matching an antenna impedance of the apparatus based upon a configuration of the apparatus.

### BACKGROUND OF THE INVENTION

In a wireless communication device, an antenna plays a crucial role in providing reliable communication. Once an antenna is selected for a specific wireless communication device, the antenna performance is generally optimized by matching its impedance to a desirable impedance, which is often determined by electronic circuits connected to the antenna. However, the antenna impedance may also be affected by a nearby object, which is electromagnetically dissapative or reflective. For example, an antenna in a wireless communication device that is matched well for free space operation in a standalone setup may work well when the device is placed on a wooden desk. However, its performance may be severely affected when it is placed on a metallic file cabinet. For a portable wireless communication device, such as a cellular telephone, it is highly likely that the cellular telephone will be placed in many varying environments affecting the antenna performance. In today's portable communication device, accessories, such as personal digital assistants (“PDAs”), digital cameras, or speaker phones, that are attachable to the portable wireless communication device are becoming increasingly popular. By attaching an accessory, an electrical characteristic of the portable wireless communication device, such as its electrical length or electrical ground plane, is likely affected. This affected electrical characteristic may degrade the antenna performance of the wireless communication device by changing the antenna impedance. Various types of foldable, rotatable, and extendable portable wireless communication devices are also becoming increasingly popular. Each of these types of portable wireless communication devices offers opened and closed positions: the closed position for a compact size for storage while not in use, and the opened position for an extended and more user friendly size when in use. However, if the antenna performance is optimized for either one of the opened or closed positions, the other position is likely to present a different electrical length or electrical ground plane to the antenna, which provides less than the optimal antenna performance.

### BRIEF DESCRIPTION OF THE DRAWINGS

FIG. 1 is an exemplary block diagram of a wireless communication device;

FIG. 2 is an exemplary block diagram illustrating signal flow and impedance matching circuit selection;

FIG. 3 is an exemplary diagram of a rotatable wireless communication device in a closed position;

FIG. 4 is an exemplary diagram of a rotatable wireless communication device in an opened position;

FIG. 5 is an exemplary diagram of a rotatable wireless communication device in an intermediate opened position;

FIG. 6 is an exemplary diagram of a foldable wireless communication device in a closed position;

FIG. 7 is an exemplary diagram of a foldable wireless communication device in an opened position;

FIG. 8 is an exemplary diagram of a foldable wireless communication device in an intermediate opened position;

FIG. 9 is an exemplary diagram of an extendable wireless communication device in a closed position;

FIG. 10 is an exemplary diagram of an extendable wireless communication device in an opened position;

FIG. 11 is an exemplary diagram of an extendable wireless communication device in an intermediate opened position;

FIG. 12 is an exemplary diagram of an attachable wireless communication device having no attachment;

FIG. 13 is an exemplary diagram of an attachable wireless communication device having a first attachment;

FIG. 14 is an exemplary diagram of an attachable wireless communication device having a second attachment;

FIG. 15 is an exemplary block diagram of an antenna impedance matching system for a retractable antenna;

FIG. 16 is an exemplary block diagram of the wireless communication device having the retractable antenna of FIG. 15 in an extended position;

FIG. 17 is an exemplary block diagram of the wireless communication device having the retractable antenna of FIG. 15 in a retractable position; and

FIG. 18 is an exemplary flow chart outlining the operation of the wireless communication device according to the present invention;

### DETAILED DESCRIPTION OF THE PREFERRED EMBODIMENTS

The present invention provides an apparatus and a method for providing an appropriate impedance matching to an antenna of a wireless communication device based upon a configuration of the wireless communication device. Examples of configurations of a wireless communication device may include, but are not limited to, a clam-shell type folding configuration having at least an opened position and a closed position, a rotatable configuration having at least an opened position and a closed position, an extendable configuration having at least an opened position and a closed position, and attachable configuration having an attachable accessory. As the configuration of the wireless communication device is changed, from the closed position to the opened position for example, the impedance at the antenna terminals may vary, due to a change in electromagnetic characteristics of the wireless communication device. This change may cause a mismatch of the antenna, and may degrade the antenna performance. Therefore it is desirable to be able to present the appropriate impedance to the antenna based upon the configuration of the wireless communication device.

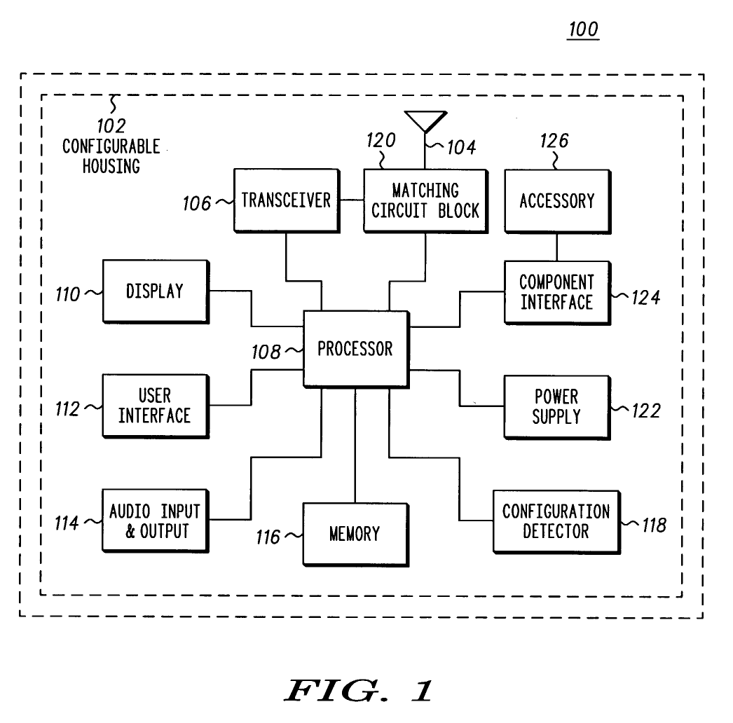

FIG. 1 is an exemplary block diagram of a wireless communication device 100 having a configuration driven automatic antenna impedance matching functionality. The wireless communication device 100 may be, but is not limited to, a radiotelephone such as a cellular phone or two-way radio, a paging device, a personal digital assistant (“PDA”), a handheld computer, an audio/video device such as a television or an MP3 player, a network browsing device, a tablet for a pen, a touchpad for a finger or a pen, a touch keypad for a finger, a virtual pen, or any type of computing and communicating device having an antenna for wireless communication. The wireless communication device 100 includes a configurable housing 102, which houses an antenna 104, a transceiver 106, a processor 108, a display 110, a user interface 112, an audio input and output 114, a memory circuit 116, a configuration detector 118 and a matching circuit block 120. The matching circuit block can include several selectable impedance matching circuits based upon the configuration of the configurable housing 102.

Upon reception of wireless signals, the wireless communication device 100 detects the signals through the antenna 104 to produce detected voice and/or data signals. The transceiver 106, coupled to the antenna 104, converts the detected signals into electrical baseband signals and demodulates the electrical baseband signals to recover incoming information, such as voice and/or data, transmitted by the wireless signals. After receiving the incoming information from the transceiver 106, the processor 108 formats the incoming information for output to the display 110 and/or audio input and output 114. Likewise, for transmission of wireless signals, the processor 108 formats outgoing information and conveys it to the transceiver 106 for modulation of a carrier and conversion into modulated signals. The transceiver 106 conveys the modulated signals to the antenna 104 for transmission to a remote transceiver (not shown).

Input and output devices of the wireless communication device 100 may include a variety of visual, audio and/or motion devices. The output devices may include, but are not limited to, the display 110 and the audio outputs such as speakers, alarms and buzzers of the audio input and output 114. The display 110 may include liquid crystal displays, light emitting diode indicators, or any other displays. The input devices may include, but are not limited to, the user input 112 and audio inputs of the audio input and output 114. The user interface 112 may include keyboards, key pads, selection buttons, touch pads, touch screens, capacitive sensors, motion sensors, switches, or any other user inputs. The audio input of the audio input and output 114 may include a microphone or any other audio input. The memory circuit 116 may be used for storing and retrieving a variety of data. The processor 108 may perform various operations to store, manipulate and retrieve information in the memory circuit 116.

The internal components of the wireless communication device 100 can further include a power supply 122, and a component interface 124. An accessory 126 from various available accessories and additional components may be coupled to the component interface 124 to provide additional functionality and capabilities to the wireless communication device 100. The power supply 122, such as a battery, is controlled by the processor 108, and provides power to the internal components so that they may function correctly.

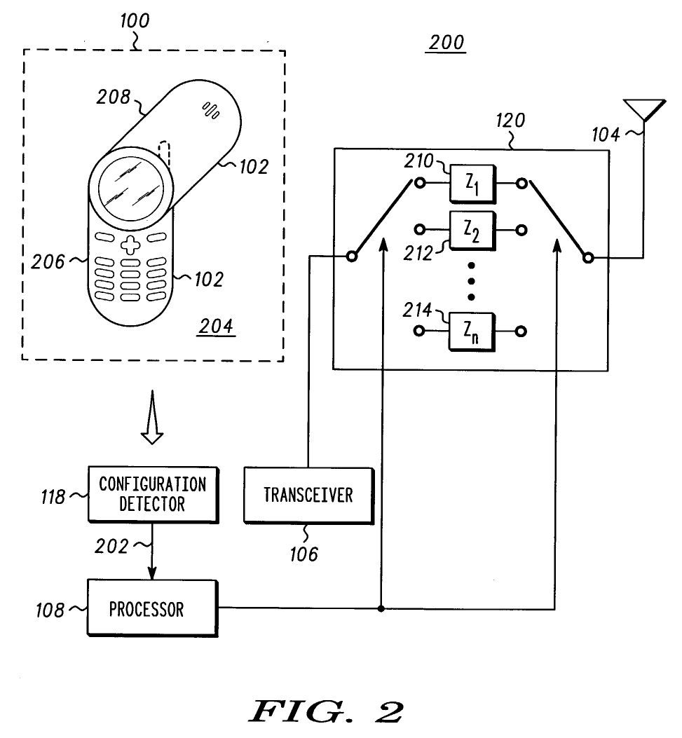

FIG. 2 is an exemplary block diagram illustration 200 illustrating signal flow and impedance matching selection. The configuration detector 118 generates a configuration signal 202 based upon the configuration 204 of the configurable housing 102 of the wireless communication device 100. Based upon the configuration signal 202, the processor 108 switches in an appropriate impedance circuit 210 from a plurality of selectable impedance matching circuits (only three impedance matching circuits, 210, 212, and 214 are shown) included in the matching circuit block 120 between the antenna 104 and the transceiver 106.

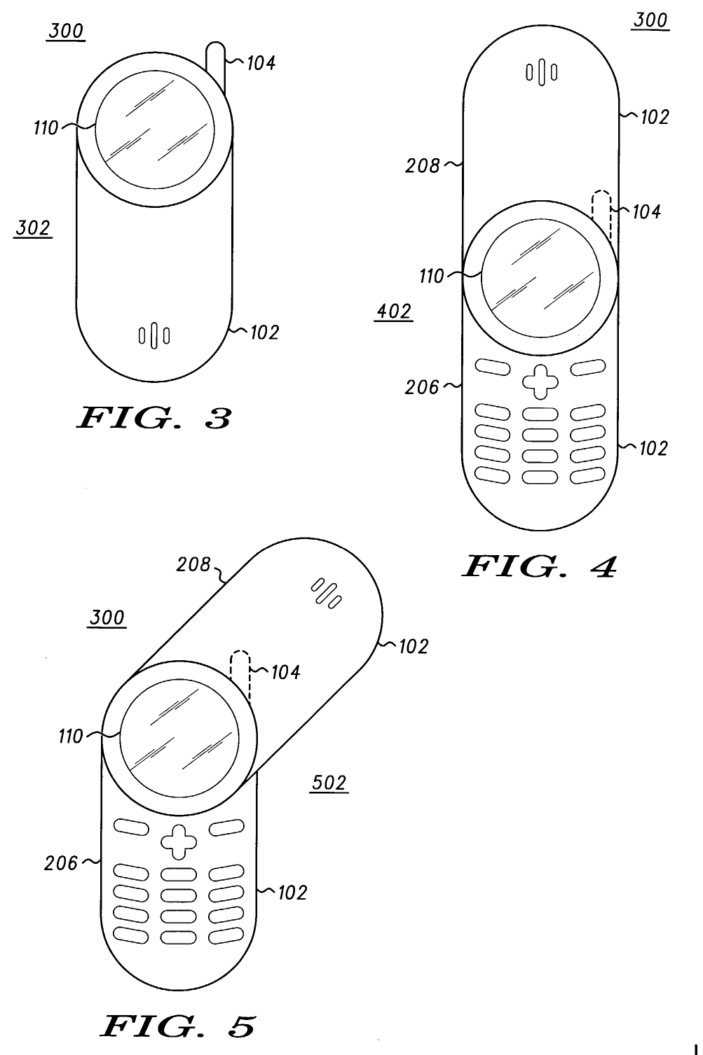

In FIG. 3, an exemplary embodiment of the present invention using a rotatable communication device 300 as an example of the wireless communication device 100 is illustrated. When the configurable housing 102 is in the closed position 302, the configuration detector 118 generates a first configuration signal indicative of the closed position 302, and transmits the first configuration signal to the processor 108. The processor 108 then selects an appropriate matching circuit for the antenna 104 from a plurality of selectable matching circuits in the matching circuit block 120 corresponding to the closed position 302. Similarly, when the configurable housing 102, now shown with first and second housings 206 and 208, is in the opened position 402, as illustrated in FIG. 4, the configuration detector 118 generates a second configuration signal indicative of the opened position 402, and transmits the second configuration signal to the processor 108. The processor 108 then selects an appropriate matching circuit for the antenna 104 from the plurality of selectable matching circuits in the matching circuit block 120 corresponding to the opened position 402. As illustrated in FIG. 5, the wireless communication device 300 may have more than the closed and opened positions 302 and 402, respectively, such as an intermediate opened position 502. The configuration detector 118 can generate a third configuration signal indicative of the intermediate opened position 502, and transmit the third configuration signal to the processor 108. The processor 108 can then selects an appropriate matching circuit for the antenna 104 from the plurality of selectable matching circuits in the matching circuit block 120 corresponding to the intermediate opened position 502.

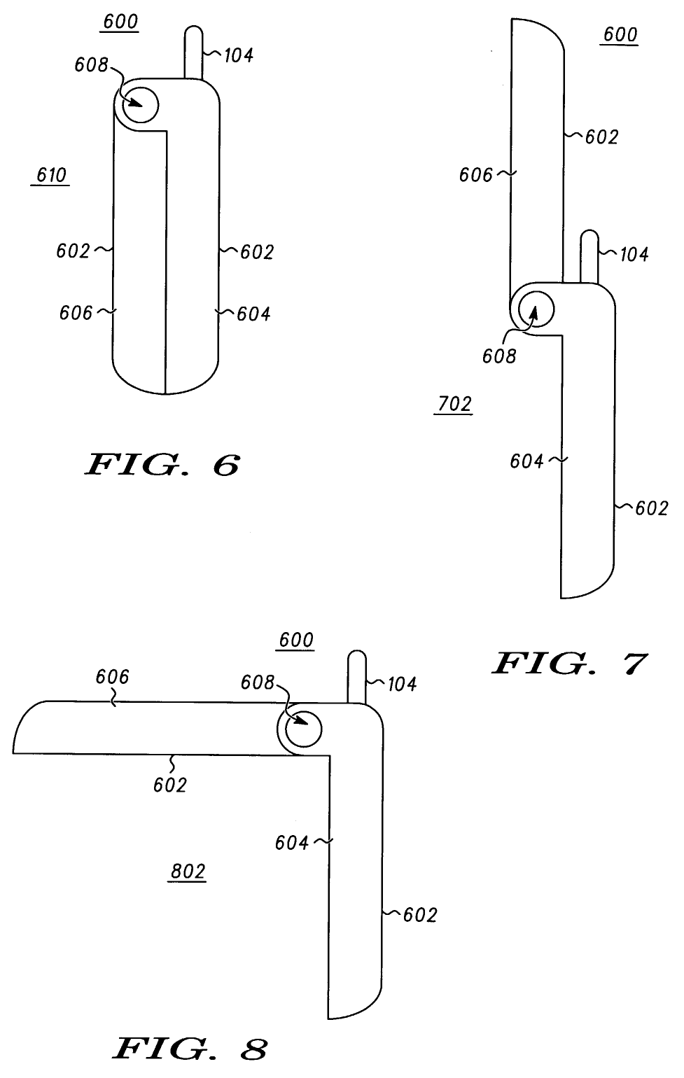

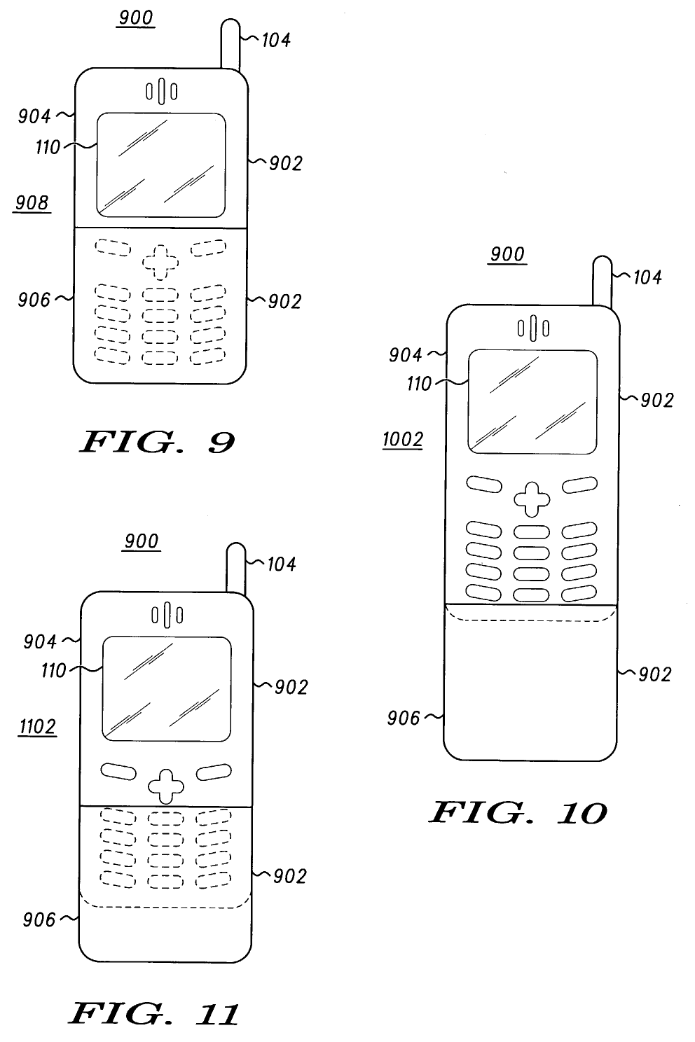

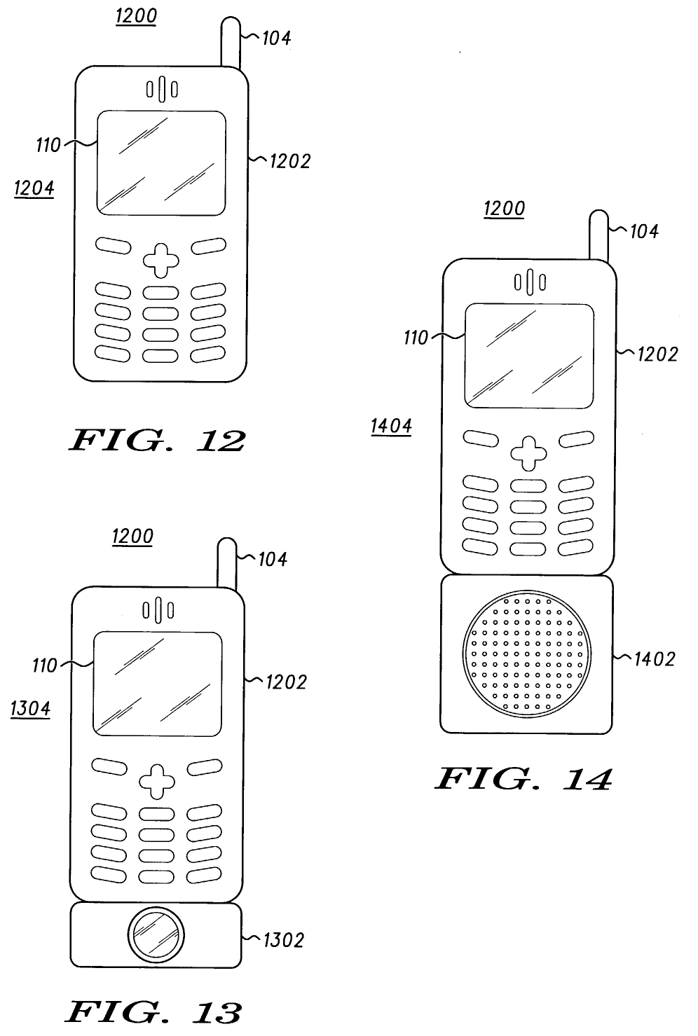

The impedance at the antenna 104 may vary based upon the configuration of the configurable housing 102 due to various factors. For example, the configurable housing 102 that is constructed from metal may affect the antenna performance by its proximity to the antenna 104. The configurable housing 102 containing electrical circuits may also have a specific electrical length or a specific ground plane configuration based upon a configuration or a relative position of the configurable housing 102. The configuration may also be affected by an attachment such as an accessory attached to one end of the configurable housing 102. Various embodiments of the wireless communication device 100 are illustrated as follows. A wireless communication device 600 having a foldable housing 602 comprising first and second housings 604 and 606 movably coupled at an axis 608 is illustrated in FIG. 6 for a closed position 610, for an opened position 702 in FIG. 7, and for an intermediate opened position 802 in FIG. 8. A wireless communication device 900 having an extendable housing 902 comprising first and second housings 904 and 906 is illustrated in FIG. 9 for a closed position 908, for an opened position 1002 in FIG. 10, and for an intermediate opened position 1102 in FIG. 1. A wireless communication device 1200 having a configurable housing 1202 with no accessory attached is illustrated in FIG. 12 as a first configuration 1204, with a first attachable accessory 1302 attached is illustrated in FIG. 13 as second configuration 1304, and with a second attachable accessory 1402 attached is illustrated in FIG. 14 as a third configuration 1404.

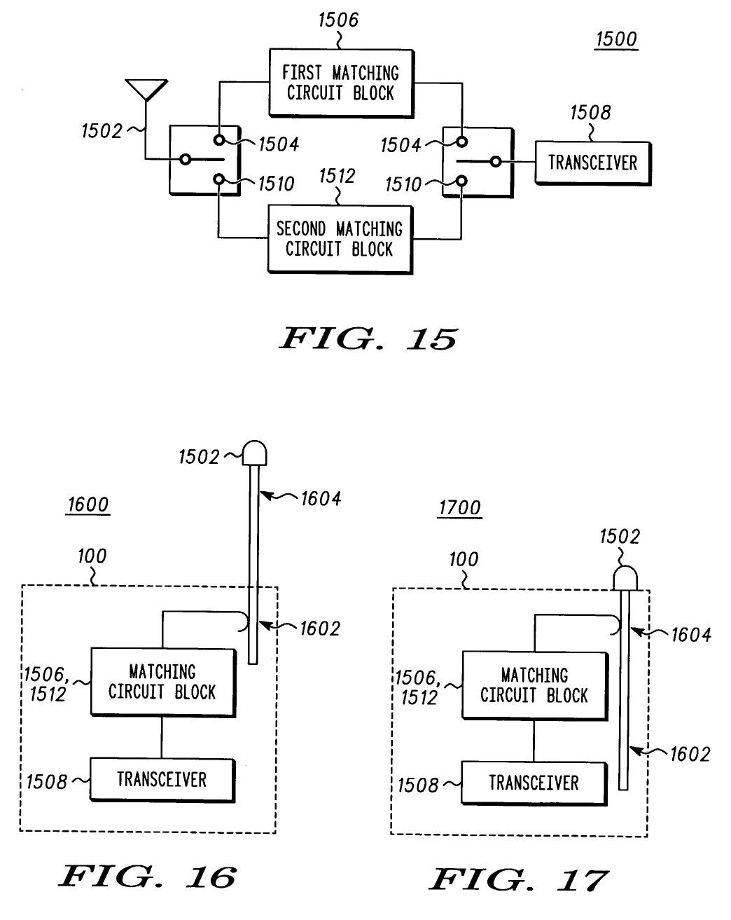

The antenna 104 illustrated in the above figures may also be a retractable type having an extended position and a retracted position. FIG. 15 is an exemplary block diagram of an antenna impedance matching system 1500 for a retractable antenna 1502. When the retractable antenna 1502 is in the extended position, which is indicated by a switch position 1504, the retractable antenna 1502 is coupled to a first matching circuit block 1506, and the first matching circuit block 1506 is coupled to a transceiver 1508. When the retractable antenna 1502 is in the retracted position, which is indicated by a switch position 1510, the retractable antenna 1502 is coupled to a second matching circuit block 1512, and the second matching circuit block 1512 is coupled to a transceiver 1508. Each of the matching circuit blocks 1506 and 1512 includes a plurality of impedance matching circuits corresponding to each of assumable configurations as shown in the matching circuit block 120 of FIG. 2.

FIG. 16 is an exemplary block diagram of the wireless communication device 100 having the retractable antenna 1502 in an extended position 1600. In the extended position 1600, the retractable antenna 1502, having a first end 1602 and a second end 1604, is coupled to the transceiver 1508 by the first end 1602 through one of the matching circuit blocks 1506 and 1512.

FIG. 17 is an exemplary block diagram of the wireless communication device 100 having the retractable antenna 1502 in a retracted position 1700. In the retracted position 1700, the retractable antenna 1502 is coupled to the transceiver 1508 by the second end 1604 through one of the matching circuit blocks 1506 and 1512.

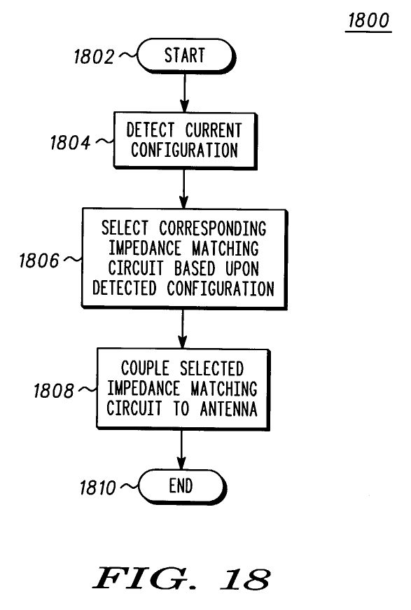

FIG. 18 is an exemplary flow chart 1800 outlining the operation of the wireless communication device 100 as illustrated above in FIG. 1 according to the present invention. The process begins in block 1802, and the configuration detector 118 detects a current configuration of the configurable housing 102 in block 1804. In block 1806, an appropriate impedance matching circuit from the matching circuit block 120 is selected. As illustrated in FIG. 2, the matching circuit block 120 comprises a plurality of impedance matching circuits, and three impedance matching circuits, 210, 212, and 214 are shown as examples in FIG. 2. Each of the plurality of impedance matching circuits corresponds to a specific configuration of the configurable housing 102, and provides an appropriate impedance for that configuration for the antenna 104. For example, the matching circuit 210 may correspond to the opened position, the matching circuit 212 may correspond to the intermediate-opened position, and the matching circuit 214 may correspond to the closed position of the wireless communication device 100. In block 1808, the selected matching circuit is coupled to the antenna 102, and the process terminates in block 1810. The configuration detector 118 may detect the current configuration of the configurable housing 102 by determining a relative position of the second housing 208 to the first housing 206. For a rotatable wireless communication device 300 as illustrated in FIGS. 3, 4, and 5, the relative position of the second housing 208 to the first housing 206 may be determined by measuring an angle made by the first and second housing 206 and 208 about the display 110. For a foldable wireless communication device 600 as illustrated in FIGS. 6, 7, and 8, the relative position of the second housing 606 to the first housing 604 may be determined by measuring an angle made by the first and second housing 604 and 606 about the axis 608. For an extendable wireless communication device 900 as illustrated in FIGS. 9, 10, and 11, the relative position of the second housing 906 to the first housing 904 may be determined by measuring how far the second housing 906 is slid down from a reference position of the second housing 906. For an attachment-ready wireless communication device 1200 as illustrated in FIGS. 12, 13, and 14, the configuration detector 118 may detects a current configuration of the configurable housing 102 by detecting presence of an attachable accessory. The configuration detector 118 may further determine an identity of the attachable accessory attached to the configurable housing to select an appropriate impedance matching circuit.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A wireless communication device comprising:
a configurable housing having a plurality of assumable configurations;
a configuration detector coupled to the configurable housing, the configuration detector configured to detect a current configuration of the plurality of assumable configurations, the configuration detector configured to generate a signal corresponding to the detected current configuration;
a transceiver housed within the configurable housing;
an impedance matching block coupled to the transceiver, the impedance matching block comprising a plurality of impedance matching circuits, each of the plurality of impedance matching circuits having a corresponding configuration in the plurality of assumable configurations;
an antenna coupled to the impedance matching block; and
a processor coupled to the configuration detector and coupled to the impedance matching block, the processor configured to receive the signal corresponding to the detected current configuration from the configuration detector, the processor further configured to select a corresponding impedance matching circuit of the impedance matching block based upon the received signal from the configuration detector.

2. The wireless communication device of claim 1, wherein the configurable housing is made of metal.

3. The wireless communication device of claim 1, wherein the configurable housing further comprises:
a first housing; and
a second housing movably coupled to the first housing.

4. The wireless communication device of claim 3, wherein the configurable housing is one of a foldable housing, an extendable housing, and a rotatable housing.

5. The wireless communication device of claim 1, wherein the configurable housing further comprises:
a first housing; and
a second housing detachably coupled to the first housing.

6. The wireless communication device of claim 1, wherein each of the plurality of assumable configurations has at least one of a corresponding electrical length and a corresponding ground plane configuration.

7. The wireless communication device of claim 1, wherein the antenna is a retractable antenna having an extended position and a retracted position, the retractable antenna comprising:
a first end, wherein the first end is coupled to the transceiver when the retractable antenna is in the extended position; and
a second end, wherein the second end is coupled to the transceiver when the retractable antenna is in the retracted position.

8. The wireless communication device of claim 7, further comprising:
a retracted impedance matching block coupled to the antenna when the antenna is in the retracted position, the retracted impedance matching block comprising a plurality of retracted impedance matching circuits, each of the plurality of retracted impedance matching circuits having a corresponding configuration in the plurality of assumable configurations when the antenna is in the retracted position,
wherein the processor is configured to select a corresponding retracted impedance matching circuit of the retracted impedance matching block based upon the received signal from the configuration detector when the antenna is in the retracted position.

9. A method in a wireless communication device having an antenna and a configurable housing for providing an appropriate impedance matching circuit for the antenna, the method comprising:
detecting a configuration of the configurable housing;
selecting an appropriate impedance matching circuit from a plurality of impedance matching circuits based upon the detected configuration of the configurable housing, the appropriate impedance matching circuit uniquely corresponding to the detected configuration of the configurable housing; and
coupling the selected impedance matching circuit to the antenna.

10. The method of claim 9, wherein detecting a configuration of the configurable housing further comprises detecting a position of a first housing of the configurable housing relative to a second housing of the configurable housing, the second housing movably coupled to the first housing.

11. The method of claim 10, further comprising opening the wireless communication device by unfolding the first housing relative to the second housing before detecting the position of the first housing relative to the second housing.

12. The method of claim 10, further comprising opening the wireless communication device by rotating the first housing relative to the second housing before detecting the position of the first housing relative to the second housing.

13. The method of claim 10, further comprising opening the wireless communication device by sliding the first housing relative to the second housing before detecting the position of the first housing relative to the second housing.

14. The method of claim 9, wherein the detecting a configuration of the configurable housing by detecting presence of an attachable accessory attached to the configurable housing.

15. The method of claim 14, wherein detecting presence of an attachable accessory attached to the configurable housing further comprises determining an identity of the attachable accessory attached to the configurable housing.

16. A wireless communication device having a matching circuit block comprising a plurality of impedance matching circuits for optimizing matching impedance between a transceiver and an antenna of the wireless communication device based upon a configuration of a configurable housing of the wireless communication device, the configurable housing having a plurality of configurations, each impedance matching circuit corresponding to a specific configuration of the plurality of configurations, the wireless communication device comprising:
a configuration detector coupled to the configurable housing for determining a current configuration of the configurable housing and for generating a configuration signal based upon the current configuration; and
a processor coupled to the configuration detector for receiving the configuration signal, wherein the processor selects an appropriate impedance matching circuit of the plurality of impedance matching circuits and couples the selected impedance matching circuit between the transceiver and the antenna based upon the configuration signal.

17. The wireless communication device of claim 16, wherein the antenna is a retractable antenna having a first end and a second ends, the retractable antenna having an extended position and a retracted position wherein the first end is coupled to the matching circuit block when the retractable antenna is in the extended position.

18. The wireless communication device of claim 17, further comprising:
an antenna position detector coupled to the retractable antenna for detecting one of the extended position and retracted position, the antenna position detector transmitting a retracted position signal to the processor when the retracted position is detected; and
a retracted impedance matching block coupled to the processor, the retracted impedance matching block comprising a plurality of retracted impedance matching circuits, each of the plurality of retracted impedance matching circuits having a corresponding configuration in the plurality of assumable configurations when the antenna is in the retracted position,
wherein the processor selects a corresponding retracted impedance matching circuit of the retracted impedance matching block in response to receiving the retracted position signal.
